(19) United States
(12) Patent Application Publication
(10) Pub. No.: US 2017/0035198 A1
(43) Pub. Date: Feb. 9, 2017

(54) SHELVING SYSTEM CONSTRUCTED USING BONDING

(71) Applicant: SPG International LLC, Covington, GA (US)

(72) Inventors: Steven Mark Kessell, Loganville, GA (US); Steven E. Darnell, Atlanta, GA (US)

(21) Appl. No.: 15/060,213

(22) Filed: Mar. 3, 2016

Related U.S. Application Data
(63) Continuation of application No. 14/496,414, filed on Sep. 25, 2014, now abandoned.
Application No. 14/496,414 is a continuation of application No. 13/880,673, filed on Dec. 6, 2013, now abandoned.
(60) Provisional application No. 61/405,523, filed on Oct. 21, 2010.

(51) Int. Cl. A47B 47/02; A47F 7/00; A47F 5/08; F16B 11/00; A47F 5/00

(52) U.S. Cl. CPC A47B 47/022; F16B 11/006; A47F 5/0018; A47F 5/08; A47F 7/0071

(57) ABSTRACT

A shelving system includes a frame including a pair of spaced apart riser members and at least one shelf extending between the riser members. The at least one shelf is adhesively bonded to the riser members. The at least one shelf may be substantially L-shaped and may include a first surface extending outwards from the riser members and a second surface angled with respect to the first surface and bonded to the riser members.

### CROSS-REFERENCE TO RELATED APPLICATION

This application is a continuation of U.S. patent application Ser. No. 14/496,414, filed Sep. 25, 2014, which published as U.S. Publication No. 2015/0223621 on Aug. 13, 2015, which is a continuation of U.S. patent application Ser. No. 13/880,673, filed Dec. 6, 2013, which published as U.S. Publication No. 2014/0083962 on Mar. 27, 2014, which is a 371 National Phase of International Patent Application No. PCT/US2011/057218, filed Oct. 21, 2011, which published as WO 2012/054804 on Apr. 16, 2012, which claims the benefit of and priority to U.S. Provisional Patent Application No. 61/405,523, filed Oct. 21, 2010. The entire contents of the foregoing applications are incorporated herein by reference.

### BACKGROUND

Shelving systems, such as equipment used in the food service industry, can be exposed to a variety of environmental conditions, including low temperatures, high temperatures, fluctuating temperatures, low humidity, high humidity, ice buildup, and corrosion. Such shelving systems must be durable to withstand heavy loads and frequent handling of stock. As a result, many shelving systems are constructed using welding, which provides a strong construction. However, welded construction also requires specialized materials and skilled laborers, which increases manufacturing costs and can result in inconsistent and inefficient fabrication.

### SUMMARY

The present invention provides easy-to-assemble shelving systems as a low cost alternative to welding for NSF-approved fabrication. In one aspect, the invention relates to a shelving system that utilizes bonding agents such as adhesives and tapes to provide secure attachment of shelves to a support frame. In one embodiment, the shelves are attached to the support structure with an adhesive that provides 20 pounds of connective strength and that can withstand temperatures ranging from 10 degrees to 400 degrees Fahrenheit.

### BRIEF DESCRIPTION OF THE DRAWINGS

FIG. 1 is a front view of a shelving system.

FIG. 2 is a left side view of the shelving system of FIG. 1.

FIG. 3 is a rear view of the shelving system of FIG. 1.

FIG. 4 is an enlarged view showing a portion of the view of FIG. 3.

FIG. 5 is a front perspective the shelving system of FIG. 1.

FIG. 6 is an enlarged view showing a portion of the view of FIG. 5.

FIG. 7 is atop view of the view of FIG. 5.

It is to be understood that the invention is not limited in its application to the details of the construction and the arrangements of components set forth in the following description or illustrated in the drawings. The present invention is capable of other embodiments and of being practiced or being carried out in various ways. Also, it is to be understood that the phraseology and terminology used herein is for the purpose of description and should not be regarded as limiting.

### DETAILED DESCRIPTION

The invention will be more completely understood through the following detailed description, which should be read in conjunction with the attached drawings. Detailed embodiments of the invention are disclosed herein; however, it is to be understood that the disclosed embodiments are merely exemplary of the invention, which may be embodied in various forms. Therefore, specific functional details disclosed herein are not to be interpreted as limiting, but merely as a basis for the claims and as a representative basis for teaching one skilled in the art to variously employ the invention in virtually any appropriately detailed embodiment.

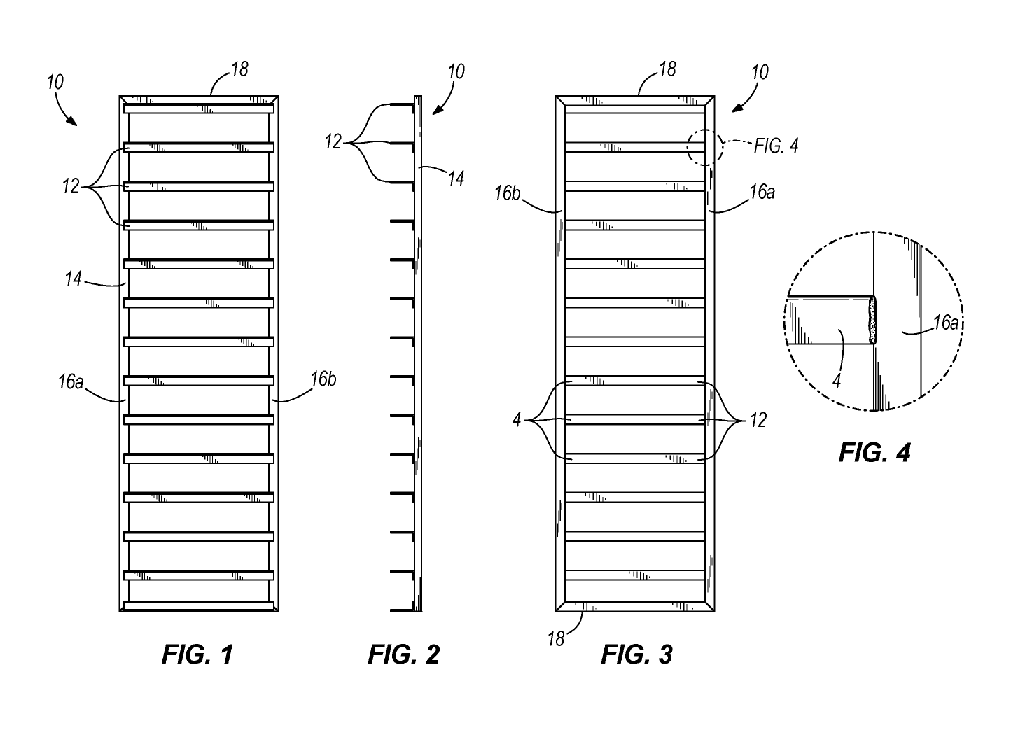

Referring to FIG. 1, a front view of a surface mounted shelf system 10 is shown in accordance with an illustrative embodiment. The system can include a plurality of shelves 12, which are mounted to a substantially vertical support frame 14. The support frame can include a pair of vertical risers 16a, 16b and one or more cross bars 18 located at the top, bottom, or middle of the vertical support frame. As shown in FIG. 2, which shows a side view of FIG. 1, the shelf system can have a substantially flat back that facilitates attachment to a smooth surface such as a wall. FIG. 3 shows a back view of the shelf system of FIG. 1.

In one embodiment, each shelf 12 forms a substantially flat and horizontal support surface 2 and a surface 4 perpendicular to the support surface 2, which serves as an attachment area to the vertical support frame 14. Thus, the support surface 2 and the surface 4 may combine to form a substantially L-shaped cross-section.

As will be appreciated, the concepts herein may be applied to shelf systems having other configurations, such as those taught in U.S. Pat. No. 7,494,019, the entire contents of which are incorporated by reference herein for all purposes.

An alternative embodiment of the shelf may include a T-shaped cross section (not shown). A T-shaped cross section advantageously increases the bonding surface area between the frame 14 and shelf, with one “side” of the T-shape being in compression and the other “side” of the T-shape being in tension. Thereby, the bonded strength between the frame 14 and the shelf is increased. In addition, the bonded area of a shelf 12 with an L-shaped cross section is either in tension or compression, depending on the specific application for which the shelf is used. Because bonded strengths in compression tend to be greater, a T-shaped cross section advantageously provides both tensile and compression forces at the bonded joint.

The support frame 14 may be made of any suitable material, such as metal (e.g., aluminum or steel) or plastic. The support frame 14 can be a single integral piece or may be formed from multiple pieces, which are joined by welding or adhesive. In some embodiments, the support frame 14 is a prefabricated unit to which shelves are later attached.

The shelves 12 can be made of any suitable material, such as metal (e.g., aluminum or steel) or plastic. The shelves 12 can be substantially flat and horizontal for stacking stored items, sloped forward for dispensing or displaying items, or can have any other suitable configuration.

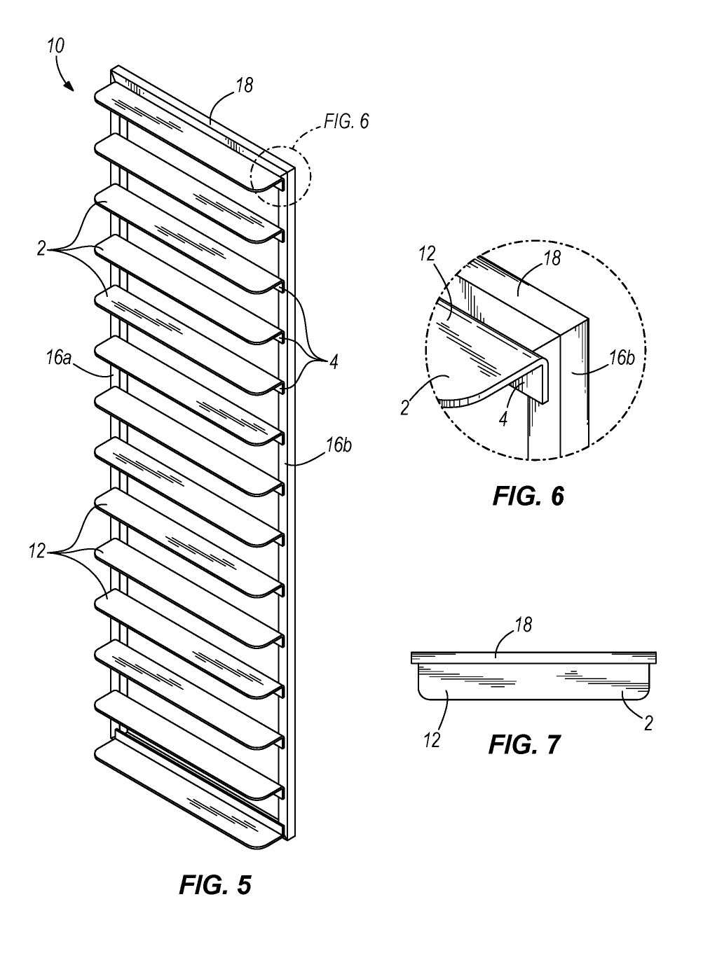

The shelves 12 are attached to the support frame 14 using a bonding material such as an adhesive, which provides a secure metal-to-metal or metal-to-plastic bond. Non-limiting examples of adhesives or bonding materials include tape, glue, epoxy, urethane, and/or acrylic. As shown in FIG. 4, that adhesive can be applied between perpendicular surface 4 and vertical riser 16a, in accordance with an illustrative embodiment.

Suitable adhesives include 3M™ Scotch-Weld™ Epoxy Adhesive 1469, either alone or in combination with other adhesives. 3M™ ScotchWeld™ Epoxy Adhesive 1469 is a one-part, 100% solids, thermosetting liquid adhesive. Other adhesives, which may be used either alone or in combination, include 3M™ Scotchweld™ Neoprene High Performance Contact Adhesive 1357, 3M™ Fastbond™ Adhesives 1099 and 1300, and 3M™ Scotch-Weld™ Epoxy, Acrylic and Urethane Adhesives and Instant Adhesives. For example, one-part epoxy adhesives are one-part, 100% solids thermosetting structural liquid adhesives that bond a variety of metals and high temperature plastics such as fiberglass reinforced plastics, polyesters and phenolics. Two-part epoxy adhesives are two-part liquids and pastes that provide high strength and elevated temperature resistance. Acrylic adhesives are two-part liquids and pastes that are designed to bond the widest variety of substances including hard-to-bond plastics and oily metals and provide a high strength bond without the surface preparation usually required for epoxies and urethanes. In addition, tapes having adhesive thereon can also be used to secure the shelves 12 to the support frame 14. Suitable tapes can include the 3M™ line of VHB™ tapes.

In one embodiment, the adhesive provides at least about 20 pounds of connective strength and can withstand temperatures ranging from about 10 degrees to about 400 degrees Fahrenheit.

While embodiments of the invention disclosed herein describe constructions based on a vertical shelf system with horizontal shelves, one skilled in art should recognize that alternative configurations may be employed without deviating from the scope of the invention.

While the invention has been described with reference to illustrative embodiments, it will be understood by those skilled in the art that various other changes, omissions and/or additions may be made and substantial equivalents may be substituted for elements thereof without departing from the spirit and scope of the invention. In addition, many modifications may be made to adapt a particular situation or material to the teachings of the invention without departing from the scope thereof. Therefore, it is intended that the invention not be limited to the particular embodiment disclosed for carrying out this invention, but that the invention will include all embodiments falling within the scope of the appended claims. Moreover, unless specifically stated, any use of the terms first, second, etc. do not denote any order or importance, but rather the terms first, second, etc. are used to distinguish one element from another.

1. A shelving system, comprising:
a frame including a pair of spaced apart riser members, and at least one shelf extending between the riser members, wherein
the at least one shelf is adhesively bonded to the riser members.

2. The shelving system of claim 1, wherein the at least one shelf is substantially L-shaped and includes a first surface extending outwards from the riser members and a second surface angled with respect to the first surface and bonded to the riser members.

3. The shelving system of claim 1, wherein the first surface is substantially perpendicular to the riser members.

4. The shelving system of claim 1, wherein the first surface includes a tilt along a horizontal direction.

5. The shelving system of claim 1, wherein the frame is made of metal.

6. The shelving system of claim 1, wherein the at least one shelf is made of metal.

7. The shelving system of claim 1, wherein the frame and the at least one shelf are made of metal.

8. The shelving system of claim 1, wherein the frame is one of metal and plastic and wherein the at least one shelf is the other of metal and plastic.

9. The shelving system of claim 2, wherein the first surface includes rounded edges.

10. The shelving system of claim 1, wherein the at least one shelf includes a plurality of shelves and the shelves are substantially parallel to each other.

11. The shelving system of claim 1, wherein the frame is formed of a single integral piece.

12. The shelving system of claim 1, wherein the shelving system is mountable to a wall.

13. The shelving system of claim 1, wherein the adhesive bond includes at least one of a tape, glue, epoxy, urethane, and acrylic.

14. The shelving system of claim 1, wherein the adhesive bond includes an epoxy adhesive.

15. The shelving system of claim 14, wherein the epoxy adhesive includes a two-part epoxy adhesive.

16. The shelving system of claim 1, wherein the adhesive bond is configured to provide at least substantially 20 pounds of connective strength.

17. The shelving system of claim 1, wherein the adhesive bond is configured to withstand temperatures of substantially 10-400° F.

18. A shelving system, comprising:
a support frame including a pair of riser members spaced apart from each other and at least one cross bar connecting the riser members; and
a plurality of shelves, each shelf attached to and extending between the riser members,
wherein the shelves are adhesively bonded to the support members, and
the shelves each including a first surface extending away from the riser members and a second surface, the second surface being angled with respect to the first surface and adhesively bonded to the riser members.
